(19) United States
(12) Patent Application Publication
(10) Pub. No.: US 2009/0285323 A1
(43) Pub. Date: Nov. 19, 2009

(54) ADAPTIVE SOFT OUTPUT M-ALGORITHM RECEIVER STRUCTURES

(76) Inventors: Carl-Erik W. Sundberg, Sunnyvale, CA (US); Haralabos Papadopoulos, San Jose, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/121,649

(22) Filed: May 15, 2008

(51) Int. Cl. H04L 1/02

(52) U.S. Cl. 375/267

(57) ABSTRACT

A method and apparatus is disclosed herein for adaptive soft output M-algorithm receiver structures. In one embodiment, a device for use in a wireless communication system includes a transmitter, and comprises of a receiver to receive information-bearing signals from the transmitter wirelessly transmitted using OFDM and bit interleaved coded modulation, where the receiver comprises an inner decoder structure having a soft output M-algorithm (SOMA) based multiple-in multiple-out (MIMO) joint demapper that uses a SOMA-based MIMO detection process to perform joint inner demapping over each subtone. The SOMA-based MIMO joint demapper is operable to identify a best candidate among a number of candidates by searching a detection tree under control of a parameter representing a total number of paths that are extended from each level, such that only a number of best alternatives from every level of the tree are expanded, wherein the SOMA-based MIMO detection process adapts one or more of the parameters based on tone quality.

### PRIORITY

The present patent application claims priority to and incorporates by reference the corresponding provisional patent application Ser. No. 60/930,805, titled, “Adaptive Soft Output M-algorithm Receiver Structures for MIMO/OFDM/QAM Systems with BICM/ID,” filed on May 18, 2007.

### FIELD OF THE INVENTION

The present invention relates to the field of wireless communication; more particularly, the present invention relates to adaptive soft output M-algorithm receivers.

### BACKGROUND OF THE INVENTION

Future wireless systems require a more effective utilization of the radio frequency spectrum in order to increase the data rate achievable within a given transmission bandwidth. This can be accomplished by employing multiple transmit and receive antennas combined with signal processing. A number of recently developed techniques and emerging standards are based on employing multiple antennas at a base station to improve the reliability of data communication over wireless media without compromising the effective data rate of the wireless systems. So called space-time block-codes (STBCs) are used to this end.

Specifically, recent advances in wireless communications have demonstrated that by jointly encoding symbols over time and transmit antennas at a base station one can obtain reliability (diversity) benefits as well as increases in the effective data rate from the base station to each cellular user per unit of bandwidth. These multiplexing (throughput) gain and diversity benefits depend on the space-time coding techniques employed at the base station. The multiplexing gains and diversity benefits are also inherently dependent on the number of transmit and receive antennas in the system being deployed, in the sense that they are fundamentally limited by the multiplexing-diversity trade-offs curves that are dictated by the number of transmit and the number of receive antennas in the system.

For high data rates and wideband transmission, the use of OFDM makes the equalizer unnecessary. With multilevel modems, coded modulation systems can easily be designed by means of an outer binary code, e.g., a convolutional code, and an interleaver in a so called bit-interleaved coded modulation (BICM) system.

In many emerging and future radio networks, the data for any particular cell user may be available to multiple base stations. Joint signaling from multiple base stations can readily extend the range/coverage of the transmission. Furthermore, viewing each of the base stations with data for a particular user as an element (or a group of elements in the case that multiple transmit antennas are present at each base station) of a virtual antenna array suggests using cooperative signal encoding schemes across these base stations to provide diversity benefits to the desired user. Since the encoded signals, however, are transmitted by spatially dispersed base-stations, they arrive at the receiver with distinct relative delays with one another, i.e., asynchronously. Although these relative delays can, in principle, be estimated at the receiver, they are not known (and thus cannot be adjusted for) at the transmitting base stations, unless there is relative-delay information feedback from the receiver to the transmitting base stations.

A large collection of STBCs have been proposed in recent years as a means of providing diversity and/or multiplexing benefits by exploiting multiple transmit antennas in the forward link of cellular systems. Of interest is the actual symbol rate of the STBC scheme, R, which is equal to k/t (i.e., the ratio of k over t). Full rate STBCs are STBCs whose rate R equals 1 symbol per channel use. Another important attribute of a STBC is its decoding complexity. Although the decoding complexity of the optimal decoder for arbitrary STBCs is exponential in the number k of jointly encoded symbols, there exist designs with much lower complexity. One such attractive class of designs, referred to as orthogonal space-time codes (OSTBCs), can provide full diversity while their optimal decoding decouples to (linear processing followed by) symbol-by-symbol decoding. Full rate OSTBCs exist only for a two transmit-antenna system. For three or more antennas, the rate cannot exceed ¾ symbols/per channel use. As a result, although the imposed orthogonality constraint yields simple decoding structures, it places restrictions in the multiplexing gains (and thus the spectral efficiencies and throughput) that can be provided by such schemes.

Many MIMO/OFDM systems exploit large-size QAM constellations and BICM/ID and have an optimum inner MIMO detector block of high complexity.

A number of systems deployed for broadcasting common audio/video information from several base stations are exploiting coded OFDM transmission under the umbrella of the single frequency network concept. These systems employ a common coded OFDM based transmission from each of the broadcasting base-stations. The OFDM based transmission allows asynchronous reception of the multitude of signals and provides increased coverage. However, as all base-stations transmit the same coded version of the information-bearing signal, SFN (single frequency network) systems do not provide in general full transmit base-station diversity with full coding gains (some form of this diversity is available in the form of multi-path diversity, although limited since it is not coordinated). A scheme with an inner modified orthogonal STBC can be viewed as a method that provides the OFDM based benefits of a single frequency network while at the same time allowing the full transmit base-station diversity and frequency diversity to be harvested from the system by using distinct coordinated transmissions from distinct base stations together with bit-interleaved coded modulation.

A class of schemes that can provide large spectral-efficiencies and reliable transmission includes space-time bit-interleaved coded modulation systems with OFDM. These systems can provide spatial (transmit and receive antenna) diversity, frequency diversity and can cope with asynchronous transmission. Furthermore, by modifying the binary convolutional code to a block with rate compatible punctured convolutional codes, a flexible UEP system can be achieved. One drawback associated with such systems is that the near-optimum receiver can be quite complex (computation intensive). The necessary joint demapper unit (inner MAP or MaxLogMAP decoder) grows in complexity exponentially with the product of the number of transmit antennas and the number of bits per modem constellation point. As an example with 16 QAM (4 bits/symbol) and 4 transmit antennas, the complexity of the calculations in the inner decoder is proportional to 2^{4×4}=2¹⁶.

It is well known that the Gray mapper for the QAM constellations is a good choice for the noniterative decoder but not for the iterative decoder.

### SUMMARY OF THE INVENTION

A method and apparatus is disclosed herein for adaptive soft output M-algorithm receiver structures. In one embodiment, a device for use in a wireless communication system includes a transmitter, and comprises of a receiver to receive information-bearing signals from the transmitter wirelessly transmitted using OFDM and bit interleaved coded modulation, where the receiver comprises an inner decoder structure having a soft output M-algorithm (SOMA) based multiple-in multiple-out (MIMO) joint demapper that uses a SOMA-based MIMO detection process to perform joint inner demapping over each subtone. The SOMA-based MIMO joint demapper is operable to identify a best candidate among a number of candidates by searching a detection tree under control of a parameter representing a total number of paths that are extended from each level, such that only a number of best alternatives from every level of the tree are expanded, wherein the SOMA-based MIMO detection process adapts one or more of the parameters based on tone quality.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 is a flow diagram of one embodiment of a decoding process.

FIG. 2 is a block diagram of one embodiment of a transmitter for space-time coding with bit-interleaved coded modulation (BICM) with OFDM modulation for wideband frequency selective channels.

FIG. 3 is a block diagram of one embodiment of a receiver having an iterative decoder for the space-time code for the OFDM system.

FIG. 4 is a block diagram of one embodiment of MIMO demapper 305 having MIMO joint demapper units for the different OFDM tones/subchannels.

FIG. 5 illustrates one embodiment of a set partition type mapper.

FIG. 6 illustrates application of the H matrix and weights to two signals.

FIG. 7 illustrates another representation of the receiver of FIG. 3 in which each MIMO demapper for each subtone is shown.

FIG. 8 illustrates the decision tree that allows a recursive computation of metrics on a tree in the case that there are three transmit antennas.

FIG. 9 illustrates an example of a decision tree.

FIG. 10 is a flow diagram of one embodiment of a process for setting up the SOMA inner decoding operation on a tone.

FIG. 11 is a flow diagram of the SOMA detection process at a particular depth.

FIG. 12 illustrates a QR decomposition.

### DETAILED DESCRIPTION OF THE PRESENT INVENTION

Embodiments of the present invention relate, in general, to adaptive receiver structures for receiving digital information over wireless systems, with multiple transmit antennas and multiple receive antennas. Embodiments of the present invention deal with flexible and efficient MIMO joint demappers based on improved versions of the soft output M-algorithm.

Such adaptive receiver structures may be used in wireless communication environments in which a mobile receives (by use of one or several antennas) a signal that is sent over multiple transmit antennas, and where the transmit antennas may be distributed over multiple base stations (i.e., they are not collocated). In one such system, the transmit antennas are collocated at the same base station.

Embodiments of the present invention include reduced complexity receivers for systems that, for example, exploit intelligent wideband transmission of the information bearing signal over the multiple independently fading paths from each transmitting base station to a receiver, in such a way that it provides transmit base station diversity, the frequency diversity available in the transmission bandwidth, receive antenna diversity if multiple receive antennas are employed, and extended coverage. Embodiments of the invention are applicable to systems, where the information-bearing signal is available at multiple base stations, and settings involving a single active base station with multiple transmit antennas. In one embodiment, a single base station with multiple transmit antennas is employed for transmission as well as OFDM-based BICM systems.

Embodiments of the present invention apply to MIMO/OFDM based systems using bit interleaved coded modulation (BICM) with iterative decoding (ID). These systems can provide full space diversity if another (outer) code with a low enough coding rate is used. If a high-rate code is used, there is a reduction in the degree of space diversity. In one embodiment, wideband transmission based on OFDM, and bit-interleaved coded modulation with an outer binary code is used. Orthogonal frequency division multiplexing, OFDM, is used to achieve flexible wideband systems. Bit interleaved coded modulation, BICM, (at the transmitter) with iterative decoding, ID, (at the receiver) is used for efficiency. The inner joint demapper is employed adaptively based on the quality of the OFDM tones. The system can be used with or without an inner orthogonal space-time block code.

The present invention is applicable to space time coding schemes for both systems with collocated base stations and non collocated base stations.

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

### Overview

A wireless communication system a first device (e.g., a base station) having a transmitter and a second device having a receiver (e.g., a mobile terminal) to receive information-bearing signals from the transmitter wirelessly transmitted using OFDM and bit interleaved coded modulation is described. In one embodiment, the communication system described herein is a coded modulation system that includes transmitters that apply space-time coding with bit-interleaved coded modulation that is combined with a multi-carrier OFDM modulation and receivers that apply OFDM demodulation with iterative demapping and decoding. The systems described herein have Nₜ transmit antennas and Nᵣ receive antennas. Each of the Nᵣ receive antennas receives signals that are the sum of channel-distorted versions of the signals transmitted from the Nₜ transmit antennas. Such coded modulation systems in accordance with the present invention may be advantageously employed in wireless local/wide area network (LAN/WAN) applications.

While the exemplary embodiment is described for space-time coding with bit-interleaved coded modulation, other types of coded modulation for space-time coding may be used. In addition, the exemplary embodiments are described for a mapping of the bit-interleaved coded data into symbols using QAM; however, other modulation schemes may be used, such as, for example, but not limited to phase-shift keying (PSK).

Generally, the receiver includes circuitry that estimates the values for the elements in channel response matrix H[k], and such estimates may be generated using periodic test (pilot) signals transmitted by the transmitter to the receiver Such a priori information of the channel impulse response may also be generated via simulations. The matrix H[k] denotes the channel response over the kth OFDM tone and is a matrix of dimensions Nᵣ by Nₜ.

When combined with signal processing, multiple transmit and receive antennas can yield communication links with increased bandwidth efficiency (data rate), extended power efficiency (range), or both. Embodiments of the invention deals primarily with the forward link, i.e., the base-to-mobile transmission direction of transmission. Methods and apparatuses are disclosed for adaptive soft output M-algorithm based receiver structures.

In one embodiment, a reduced complexity soft output MIMO detector in the receiver makes adaptive use of a modified soft output M-algorithm (SOMA). In one embodiment, the soft output MIMO detector is applied for every tone or subchannel in the OFDM system, as well as at every iteration in the decoding process. To illustrate the advantages of the SOMA demapper, consider the optimum MIMO detector, referred to as a maximum a posteriori probability (MAP) detector. The MAP performs a joint demapping function over all the transmit antennas and over all the involved QAM constellation symbols and bits. Often the asymptotically optimum but much simpler exhaustive MaxLogMAP detection algorithm is used. However, even in the simpler MaxLogMAP detector an exhaustive demapping operation is required and it involves a search space that is growing exponentially with the product of the number of transmit antennas (Nₜ) and the number of bits per QAM constellation point (B). For example, with a 6 by 6 MIMO system (6 transmit antennas and 6 receive antennas) using 64 QAM modulation (6 bits per constellation point) this product is 36. In such a case, the decoding complexity is of the order of 2³⁶, and the MaxLogMAP cannot be implemented with the technology of today. In contrast, in one embodiment, the SOMA detector only uses a fraction of the total number of candidates in its MIMO detection process, thus the considerable complexity reduction. There is of course a tradeoff between the performance and the degree of complexity reduction. In one embodiment, the SOMA is used adaptively, in that the amount of computation allocated to each SOMA module (one per OFDM tone) is adapted to the channel conditions (on the given OFDM tone) in order to optimize the overall complexity-performance trade-offs of the receiver.

During every inner/outer decoder iteration, a SOMA detector performs a SOMA detection process on each OFDM tone. In one embodiment, the number of candidates explored in the SOMA detection process is controlled by the parameter (M) that indicates the number of paths that are extended from each node or level in the detection tree. In particular, at any given level in the detection tree, only a subset M of the visited candidates are kept as survivors and are going to be extended at the next level. The rest of the candidates tested at this level are referred to as early-terminated paths. The early terminated paths are used by the SOMA for performing soft-output calculations. In one embodiment, the number of early terminated paths that are explored in the SOMA detection process is also an adaptation parameter as these paths also play a role in the soft output calculations. For purposes herein, this value is denoted T and is used in the soft output value calculation by the algorithm. In the overall detection process the number of inner/outer decoder iterations, I, also affects the total decoding complexity and the associated performance.

In one embodiment, the parameters M and T and/or I are selected adaptively for the best overall performance for a given total complexity level, with the quantity that guides the adaptivity being the quality of the different OFDM tones. For example, a high signal level or alternatively a large signal to noise ratio (SNR) for a certain tone means a good quality level for that tone. In such a case, the SOMA detection process performs decoding with a lower value of M, a lower value of T and potentially a lower value of I. On the other hand, for a tone of poor quality, i.e. a tone with low signal level or low SNR, the SOMA detection process performs decoding with higher values of M, T and I for the best use of the overall complexity. The adaptivity can also be extended over time, i.e. over successive OFDM symbols.

In one embodiment, the space-time coding system described herein comprises OFDM for wideband transmission, MIMO and large QAM constellations for high spectral efficiency, a bit interleaver for the bit-interleaved coded modulation scheme (BICM) and an outer binary code. The overall detection is typically performed iteratively. This requires that both the inner MIMO demapper and the outer decoder perform soft in soft out (SISO) detection/decoding. One system component contributing to the complexity is typically the joint demapper as explained above. The outer code is less critical in terms of complexity. In one embodiment, the MIMO detector in principle works with any binary outer code. This code could be a turbo code, an LDPC code, a regular convolutional code or an RCPC code. The decoder for the outer code is preferably a soft in soft out (SISO) type decoder, for example a MAP decoder. The outer decoder supplies soft information to the inner MIMO detector for iterative decoding.

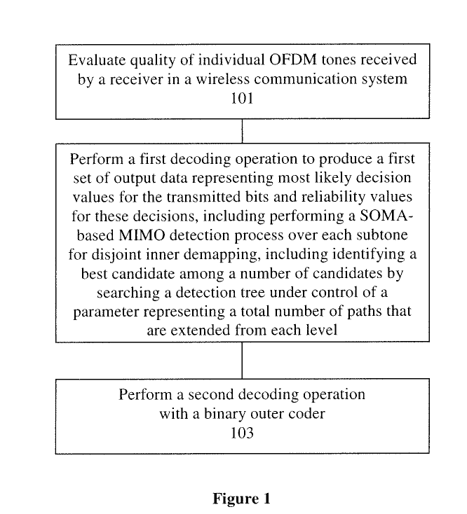

FIG. 1 is a flow diagram of one embodiment of a decoding process. The process may be performed by processing logic that may comprise hardware (e.g., dedicated logic, circuitry, etc.), software (such as is run on a general purpose computer system or a dedicated machine), or a combination of both. In one embodiment, the decoding process is performed by a receiver in the wireless communication system.

Referring to FIG. 1, the process begins by processing logic evaluating quality of individual OFDM tones received by a receiver in a wireless communication system (processing block 101). The quality of the individual OFDM tones/subchannels is evaluated/estimated at the receiver. In one embodiment, the quality of OFDM tones is based on signal level. In another embodiment, the quality of OFDM tones is based on signal-to-noise ratio (SNR).

After evaluating the quality of OFDM tones, processing logic performs a first decoding operation to produce a first set of output data representing most likely decision values for the transmitted bits and reliability values for these decisions, including performing a SOMA-based MIMO detection process over each subtone for disjoint inner demapping, in which a best candidate is identified among a number of candidates by searching a detection tree under control of a parameter representing a total number of paths that are extended from each level, such that only a predetermined number of best alternatives from every level of the tree are expanded (processing block 102). In one embodiment, performing decoding comprises calculating soft output values at every level by computing a metric difference between the estimated best path at that level and each of all or a subset of early-terminated paths at that level, and whereby each such metric difference is used to update bit locations for which two paths (based on which the metric difference is computed) disagree in value. In one embodiment, a soft-in soft-out (SISO) outer decoder uses the soft output values from the inner SOMA-based MIMO joint demapper to produce output data and feeds soft values back to the inner decoder structure for iterative decoding. In another embodiment, a soft-input hard-output Viterbi decoder uses the soft output values from the inner SOMA-based MIMO joint demapper to produce hard output data for non-iterative decoding. Note that in such a case, a simpler outer decoder is used to produce the hard outputs.

In one embodiment, the SOMA-based MIMO detection process is adapted based on the number of early-terminated paths in the tree (T), which are used in soft-output value calculations. In another embodiment, the SOMA-based MIMO detection process is adapted based on the number of iterations for each tone based on tone quality. In yet another embodiment, the SOMA-based MIMO detection process is adapted during each iteration and for every tone based on tone quality. In another embodiment, the SOMA-based MIMO detection process adapts one or more of the parameters, a number of early-terminated paths in the tree, and a total number of iterations based on tone quality.

After performing the first decoding operation, processing logic performs a second decoding operation with a binary outer coder (processing block 103). In one embodiment, the outer decoder comprises a MAP decoder for the associated convolutional code used as an outer encoder in the transmission system. The outer decoder may comprise a conventional optimal or suboptimal decoder for a rate-compatible punctured convolutional (RCPC) code, a turbo code and a LDPC code, when such a binary code is used as an outer encoder in the transmission system.

### Transmitter and Receiver Embodiments

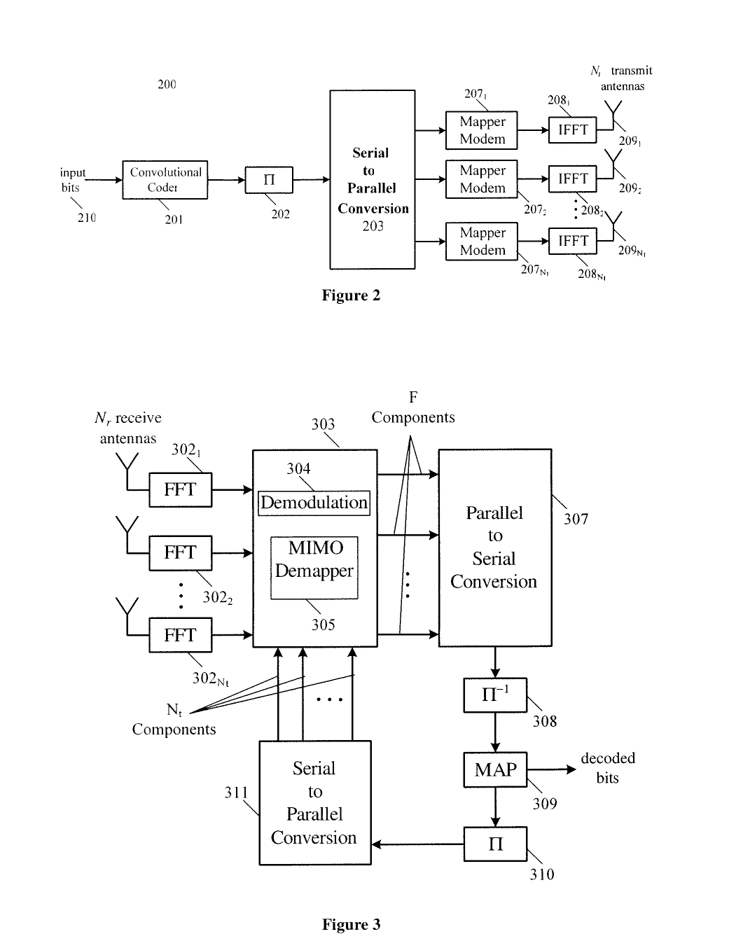

FIGS. 2 and 3 show the transmitter and receiver block diagrams for a MIMO/OFDM system with BICM and ID. More specifically, FIG. 2 is a block diagram of one embodiment of a transmitter for space-time coding with bit-interleaved coded modulation (BICM) with OFDM modulation for wideband frequency selective channels. Referring to FIG. 2, transmitter 200 comprises convolutional encoder 201, bit interleaver 202, serial-to-parallel converter 203, mapper modems 207₁-207_{Nt}, inverse fast Fourier transform (IFFT) modules 208₁-208_{Nt}, and transmit antennas 209₁-209_{Nt}. Note that IFFT modules 208₁-208_{Nt} also include circular-prefix operations, which are performed in a manner that is well known in the art.

To perform BICM encoding to the data, convolutional coder 201 applies a binary convolutional code to the input bits (input data) 210. Bit interleaver 202 then interleaves the encoded bits from convolutional coder 201 to generate bit-interleaved encoded bits. This bit interleaving de-correlates the fading channel, maximizes diversity, removes correlation in the sequence of convolutionally encoded bits from convolutional coder 201, and conditions the data for increased performance of iterative decoding. Convolutional coder 201 and bit interleaver 202 may typically operate on distinct blocks of input data, such as data packets.

After performing bit interleaving, bit-mapping and modulation and OFDM are applied to the bit-interleaved encoded bits. Serial-to-parallel converter 203 receives the serial bit-interleaved encoded bit stream from bit interleaver 202. Note that serial-to-parallel converter 203 may include a framing module (not shown) to insert framing information into the bit stream, which allows a receiver to synchronize its decoding on distinct blocks of information. Serial-to-parallel converter 203 generates a word of length Nₜ long, with each element of the word provided to a corresponding one of mapper modems 207₁-207_{Nt}. Elements of the word may be single bit values, or may be B bit values where B is the number of bits represented by each modem constellation symbol.

Each of mapper modems 207₁-207_{Nt} converts B bits to corresponding symbols (of the Q-ary symbol space, with Q=2^{B}). The output of each modem mapper 207 is a symbol. Each of IFFT modules 208₁-208_{Nt} collect up to F symbols, and then apply the IFFT operation of length F to the block of F symbols. F is an integer whose value can typically range from as small as 64 to 4096, or larger and depends on the available transmission bandwidth, the carrier frequency, and the amount of Doppler shifts that need to be accommodated by the system. Thus, each of IFFT modules 208₁-208_{Nt} generate F parallel subchannels that may be transmitted over corresponding antennas 209₁-209_{Nt}. Each subchannel is a modulated subcarrier that is transmitted to the channel.

In embodiment, the transmitter and receivers have an equal number of transmit and receive antennas, i.e., Nₜ=N_{T}=N. The binary information bearing signal, hereby denoted as uₖ, is encoded first at the transmitter by an outer binary code using convolutional coder 201, generating a coded sequence cₖ. This sequence is interleaved by a pseudorandom bit interleaver 202. Then, each of mapper modems 207₁-207_{Nt} maps groups of B interleaved bits at a time into 2^{B}-QAM symbols. The resulting QAM symbols are multiplexed through the N transmit antennas 209₁-209_{Nt} in a round-robin fashion and OFDM transmission is applied over each antenna using IFFT modules 208₁-208_{Nt}. For convenience, for purposes herein, sₖ[n], the QAM symbol transmitted by antenna k on tone n, and via bₖ^{l}[n] the lth out of the B bits is used as input in one of mapper modems 207₁-207_{Nt} to produce sₖ[n]. Letting bₖ[n]=[bₖ¹[n], bₖ²[n], . . . , bₖ^{B}[n]], then,

sₖ[n]=map(bₖ[n]) (1)

where map denotes the mapper operation.

FIG. 3 is a block diagram of one embodiment of a receiver having an iterative decoder for the space-time code for the OFDM system. Referring to FIG. 3, receiver 300 comprises receive antennas 301₁-301_{Nr}, fast Fourier transform (FFT) modules 302₁-302_{Nr}, demodulator/detector 303, parallel-to-serial converter 307, bit deinterleaver 308, maximum a posteriori (MAP) decoder 309, bit interleaver 310, and serial-to-parallel converter 311. Although not shown, each of the FFT modules 302₁-302_{Nr} is preceded by front end that performs filtering, band-rate sampling, and a circular-prefix-removal operation.

For a wideband system, receiver 300 performs OFDM demodulation for each of receive antennas 301_{1-Nr}, and the demodulation and demapping is performed over F parallel subchannels. The ith receive antenna 301(i) senses a signal made up of various contributions of the signals transmitted from the Nₜ transmit antennas (i.e., contributions of the multiple F parallel, narrowband, flat fading subchannels transmitted over corresponding antennas 209₁-209_{Nt} of FIG. 2). Each of FFT modules 302₁-302_{Nr} apply an F-point FFT to the corresponding signals of receive antennas 301₁-301_{Nr}, generating N, parallel sets of F subchannels.

In one embodiment, demodulator/detector 303 estimates bits in each of the F subchannels (slowly varying with flat fading) rather than in only one subchannel as in the narrowband, flat fading systems of the prior art. Demodulator 304 demodulates F subchannel carriers to baseband for each of the Nᵣ parallel sets of F subchannels. Multi-input multi-output (MIMO) demapper 305, based on the Nᵣ parallel sets of F subchannels from FFT modules 302₁-302_{Nr} produces MAP estimates of the demapped bits (i.e, bits mapped from the constellation symbol) in each of the F subchannels from the Nₜ antennas in the transmitter. MIMO demapper 305 produces the estimates of the demapped bits and reliability information about these bits using reliability information generated by soft-output decoding (followed by reinterleaving) by MAP decoder 309.

In one embodiment, MIMO demapper 305 computes soft values for bits transmitted on the overlapping F subchannels, along with an estimate (approximation) of the a posteriori probability of the soft value being correct. This is performed in a manner well-known in the art.

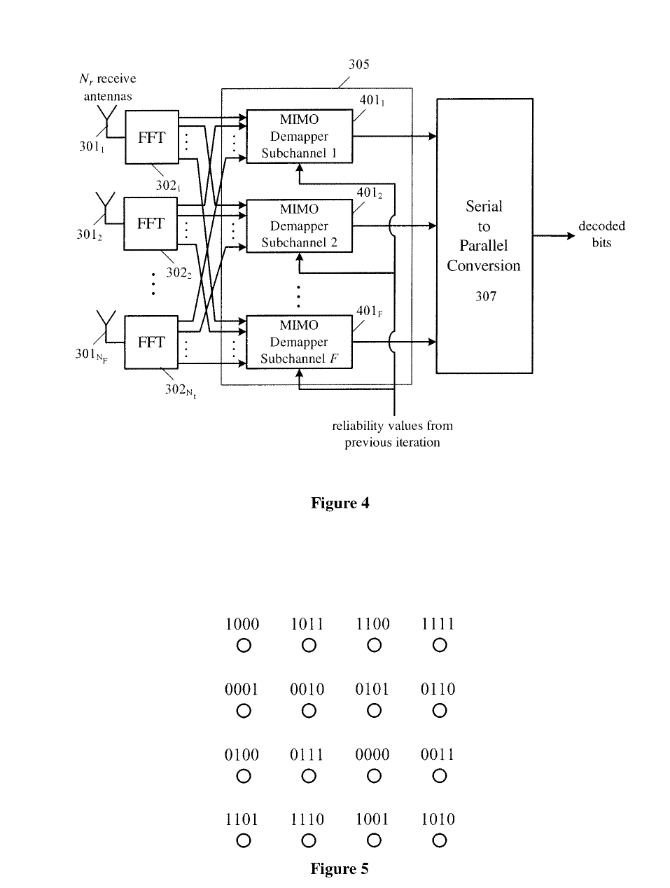

FIG. 4 is a block diagram of one embodiment of MIMO demapper 305 having MIMO joint demapper units for the different OFDM tones/subchannels. Referring to FIG. 4, each signal of the Nᵣ receive antennas 301₁-301_{Nr} is divided into F subchannels (via demodulator 304, not shown in FIG. 4) by applying the FFT and sent to corresponding subchannel MIMO demappers 401₁-401_{F}. The signal outputs of the kth subchannel for all Nᵣ receive antennas are provided to the kth subchannel MIMO demapper 401(k), reliability information using extrinsic information generated from the output of MAP decoder 309 of the previous iteration. The extrinsic information is exchanged between MIMO demapper 305 and MAP decoder 309 to improve the bit error rate performance for each iteration. Methods for computing the extrinsic information in such inner/outer decoder settings are well-known in the art. In the first iteration, there is no extrinsic information input to the soft demapper. In subsequent iterations, in one embodiment, the extrinsic information is computed as follows. First, the soft-output is computed by the MAP outer decoder, and from it the input reliability information (input to the same outer decoder) is subtracted off in order to compute the extrinsic information produced by MAP decoder 309. This extrinsic information is deinterleaved and passed as input to MIMO demapper 305 in the next iteration.

Returning to FIG. 3, the estimates of bits in F parallel streams from MIMO demapper 305 together with reliability values for those bits are provided to parallel-to-serial converter 307 along with the extrinsic reliability information on each one of these bits. The reliability information is computed as the difference between the output reliability values for those bits (produced by demapper 305) and the input reliability values for those bits (inputs to demapper 305). The converter 307 reconstitutes the estimate of the BICM encoded bit stream generated by the transmitter, which was estimated by the receiver 300. The estimated BICM encoded bit stream (and the extrinsic reliability information) is then deinterleaved by bit deinterleaver 308 and applied to MAP decoder 309 to reverse the convolutional encoding applied by the transmitter. The reverse operation in this case corresponds to generating estimates of the bit values of the information bit stream that is the input to convolutional coder 201, and also producing extrinsic information that is to be passed back (after reinterleaving) to MIMO demapper 303 as new reliability information.

The MAP decoding process generates soft output values for transmitted information bits in a manner that is well known in the art.

The extrinsic information from MAP decoder 309 is first applied to bit interleaver 310. Bit interleaving aligns elements of the extrinsic information with the interleaved estimated BICM encoded bitstream from MIMO demapper 305. In addition, the interleaved extrinsic information is applied to serial-to-parallel converter 311, which forms Nₜ parallel streams of extrinsic information corresponding to the parallel bit streams formed at the transmitter.

The extrinsic information is exchanged between MIMO demapper 305 and MAP decoder 309 to improve the bit error rate performance for each iteration. In one embodiment, a MaxLogMAP-type approximation is used to compute bit-LLR values for each bit location. In another embodiment, an improved Max-Log approximation for calculation of LLRs can be used in both MIMO demapper 305 and in MAP decoder 309 associated with the convolutional code used as an outer encoder in the transmission scheme. The improved Max-Log approximation for calculation of a posteriori LLR values may employ the max* term relationship of the following equation:

max*(x,y)=log(e^{x}+e^{y})=max(x,y)+log(1+e^{-|x-y|})

when calculating updated forward recursive, reverse recursive, and branch metrics sequences to calculate the LLR. Each constituent MIMO demapper 305 or MAP decoder 309 thus calculates the max* term by separate calculation of a max term (max(x,y)) and a logarithmic correction term (log(1+e^{-|x-y|})).

FIG. 5 illustrates one embodiment of a so called set partition type mapper for 16QAM for use in iterative decoding. This type of mapper is suitable for BICM with iterative decoding (ID) in contrast to the Gray mapper which is suitable for a non-iterative decoding process.

### An Example of an Inner Decoder Structure

After OFDM front-end preprocessing, the samples from each receive antenna and on each tone are passed through an inner/outer soft-in soft-out decoder structure for decoding shown in FIGS. 3 and 4, which are described above. Also as described above, in one embodiment, the outer decoder is an optimal (soft-in soft-out) BCJR decoder. The complexity of the near-optimal receivers associated with these types of coded OFDM/BICM/OFDM systems resides in the inner decoder of the receiver structure in FIG. 3. The received signal sample on the mth receive antenna and the nth tone can be expressed as

$${y}_{m} [ n ] = {\sum }_{k} {h}_{km} [ n ] {s}_{k} [ n ] + {w}_{m} [ n ] \qquad ( 2 )$$

where hₘₖ[n] denotes the effective channel gain between the kth transmit and the mth receive antenna on the nth tone, wm[n] denotes the associated thermal noise term on the mth antenna and nth tone. Alternatively, (2) can be compactly reexpressed as follows,

y[n]=H[n]s[n]+w[n] (3)

where h[n]=[h₁[n] h₂[n] . . . h_{N}[n]]^{T} with hₘ[n]=[h₁ₘ[n] h₂ₘ[n] . . . h_{Nm}[n]]^{T}, and where s[n]=[s₁[n] s₂[n] . . . s_{N}[n]]^{T}, and y[n] and w[n] are similarly defined and where it is assumed that Nₜ=Nᵣ=N.

It is assumed that channel state information (CSI) is not available at the transmitter, but CSI is fully available at the receiver; that is, the set of H[n]'s are assumed to be known at the receiver but not at the transmitter.

On each OFDM tone, N QAM symbols are transmitted simultaneously and each of the N receive antennas receives a linear combination of these N symbols (whereby the linear combination is dictated by the instantaneous channel coefficients). In one embodiment, the complexity of an optimal (hard- or) soft-output inner decoder is dictated by the number of possible N tuples of 2^{B}-QAM symbol candidates, which is of the order of C=(2^{B})^{N}=2^{BN}, where B is the number of bits per QAM signal point and N is the number of transmit antennas. The complexity measure C indicates the number of terms needed in order to form the log-likelihood ratio (LLR) in the joint demapper (inner decoder). This is also the number of terms checked by the MAP or the MaxLogMAP decoder. As an example, for the 4×4 16-QAM (1 Gb/s) system [2], we have C=2¹⁶, while for the 6×6 64-QAM (2.5 Gb/s) and 12×12 64-QAM (5 Gb/s) systems, the value of C get in the clearly “impractical range” of C=2³⁶ and C=2⁷², respectively.

As stated above, in one embodiment, the receiver uses a modified version of the soft output M-algorithm (SOMA). The SOMA is well known in the art; see for example, Wong, “The Soft Output M-algorithm and its applications”, Ph.D. Thesis, Queens University, Kingston, Canada, August 2006, incorporated herein by reference. In one embodiment, the modified soft output M-algorithm (SOMA) is used adaptively. The M-algorithm is well known in the art and is described in Lin & Costello, “Error Control Coding, 2^{nd} Edition,” Prentice Hall, New York, 2003.

In contrast to the basic M-algorithm which does not give soft output values, in one embodiment, the joint demapper uses the modified SOMA for finding the best alternative among an exponentially growing population of candidates by doing a reduced search in a detection tree. This is done by expanding only the M best alternatives from every level of the tree rather than all alternatives. In one embodiment, the M best alternatives are determined using a metric. In one embodiment, the metric is so called MaxLogMAP type metric, such as described in Lin & Costello, “Error Control Coding, 2^{nd} Edition,” Prentice Hall, New York, 2003, which is well-known in the art.

Based on the search through the detection tree, the joint demapper calculates soft output values by comparing the estimated best path with the best alternative paths branching off the best path. These paths though the levels of the tree could be terminated at the end of the tree (there are M such paths) or non-terminated at every level (there are T early-terminated paths). That is, the SOMA detection process performs these soft output calculations iteratively during the tree search in the algorithm, whereby at each depth in the tree it uses early terminated paths at that depth and the best candidate at the same depth for computing reliability values for all the bit locations that is possible.

The soft output values from the inner SOMA-based MIMO joint demapper are then used by the soft in soft out (SISO) decoder for the outer binary code. This decoder in turn feeds soft values back to the inner decoder in an iterative turbo-type iterative decoding. In another embodiment, a soft-input hard-output Viterbi decoder (i.e., a simpler outer decoder) uses the soft output values from the inner SOMA-based MIMO joint demapper to produce hard output data for non-iterative decoding.

In one embodiment, the inner decoder is channel-adaptive. Such channel-adaptive versions of SOMA inner decoders save in complexity (with respect to the base SOMA designs) without appreciable reduction in performance, as well as being optimizable for a given channel realization to a desired target BER performance.

In one embodiment, the SOMA algorithm computes (estimated) symbol decision values and reliability information for the associated bit estimates by first turning the computation above into a computation on a tree and then performing approximate maximization computations by limiting the search through the tree.

Next the focus is on the SOMA operating on a fixed but arbitrary OFDM tone n. For convenience we omit the dependence of all variables vectors and matrices on the OFDM index, n. In one embodiment, the mapping of the MaxLogMAP demapper computations on a tree structure is based on exploiting the QR-type decompositions of the channel matrix is described. Let π: {1, . . . , N}: {1, . . . N} denote a permutation function, s^{(π)}=[s_{π(1)}s_{π(2)} . . . s_{π(N)}]^{T} denote the associated N-symbol permutation of s, and P^{(π)} denote the associated permutation matrix, i.e., the matrix yielding s^{(π)}−P^{π}s.

Associated with any fixed order π, the decomposition expresses the channel matrix H from equation (3) as H^{(π})=H[P^{(π)}]^{T} in the form H^{(π)}=Q^{(π)}L^{(π)} with Q^{(π)} unitary and L^{(π)} lower triangular. As a result, the information lossless projection operation of y onto [Q^{(π)}]^{H} yields a vector \tilde{y} that constitutes a set of measurements that are equivalent to those in y from equation (3) and which can be represented as follows

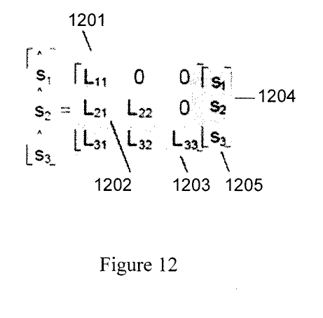

\tilde{y}=L^{(π)}s^{(π)}+\tilde{w}. (4)

whereby lᵢⱼ^{(π)}={L^{π}}i, j, and lᵢⱼ^{(π)}=0 when i>j See FIG. 12 for an example, where the structure of the first term in the right hand side of equation (4) is illustrated for Nₜ=Nᵣ=N=3.

Given an equation for \tilde{y} given above, the full-search MaxLogMAP can be readily implemented based on the above set of measurements via a search on a tree. At depth k in the tree, only the k first equations are considered from equation (4) to rank candidates. As these equations depend only on the k first symbols in s^{(π)}, the sets of candidates are ranked in groups whereby each group corresponds to all the N-symbol candidates that have the same symbol values in the first k symbols in the order described by π. In particular, letting \tilde{s}, denote an arbitrary N×1 vector of 2^{B} QAM symbol values, \tilde{s}ₘ=[\tilde{s}]ₘ, and {\tilde{b}ₘ¹,\tilde{b}ₘ², . . . \tilde{b}ₘ^{B},} denote the associated values of the kth bits that map to \tilde{s}ₘ, the MaxLogMAP computation reduces to

$$\begin{matrix}L ( {\tilde{b}}_{m}^{k} ) = {max}_{\tilde{s} : {\tilde{b}}_{m}^{k} = 1} Γ ( \tilde{s} , \hat{s} ) - {max}_{\tilde{s} : {\tilde{b}}_{m}^{k} = 0} Γ ( \tilde{s} , \hat{s} ) \\ where \hat{s} = {[ {L}^{( π )} ]}^{- 1} y and & ( 5 ) \\ Γ ( \tilde{s} , \hat{s} ) = {\sum }_{m = 1}^{N} {‖ {l}_{mm}^{( π )} ( {\tilde{s}}_{m} - {\hat{s}}_{m} ) + {\sum }_{n = 1}^{m - 1} {l}_{mn}^{( π )} ( {\tilde{s}}_{n} - {\hat{s}}_{n} ) ‖}^{2} & ( 6 )\end{matrix}$$

The quantities Γ(\tilde{s},ŝ) can be readily implemented recursively via a full tree-search on a tree of depth N and 2^{B} branches per node.

The SOMA algorithm, in essence, performs a limited MaxLogMAP-metric based search on the tree. Like any M-algorithm, from all surviving candidates at any given level, all possible candidates are expanded to the next level (2^{B}M in this case), but only a subset M of those is kept for search at higher depths in the tree. An important element of the SOMA is that it recursively generates and updates quality metric estimates for each value of each of the NB bits represented on the tree. In particular, it exploits the use of two N×B matrices Δ⁽⁰⁾ and Δ⁽¹⁾, whereby the relative reliability metrics associated with the values 0 and the 1 of the kth bit in sₘ are given by δ⁽⁰⁾_{m,k}=[Δ⁽⁰⁾]_{m,k} and δ⁽¹⁾_{m,k}=[Δ⁽¹⁾]_{m,k}, respectively. The scheme relies on recursively extending each surviving path at level m to its 2^{B} path extensions at the next level, computing the cumulative metrics for the new paths and sorting the paths in the order of decreasing metrics. If p_{[l,i],r} denote the rth ranked path at depth I, then the M top paths, i.e., the paths in the set {p_{[l,i],r}; 1≦r≦M} are retained, while the paths in {p_{[l,i],r}; r>M} are terminated. However, a subset of the best Nₜₑᵣₘ terminated paths {p_{[l,i],r}; M+1≦r≦M+Nₜₑᵣₘ} are still used before they are discarded for producing relative reliability updates for the bits and bit values they represent by updating the associated locations in [Δ⁽⁰⁾] and [Δ⁽¹⁾]. After the completion at depth N, the SOMA first chooses the surviving length-N path with the best accumulated metric as the hard estimate. This N×1 vector of QAM symbol estimates is used to directly demap and obtain hard estimates for the NB bits {\tilde{b}ₘ^{k}; 1≦k≦B, 1≦m≦N}. Reliability metrics are updated in the two matrices based on all length N tree candidates 2≦r≦M=Nₜₑᵣₘ. Then the relative reliability information for the kth bit represented in the mth QAM symbol is given by

L(bₘ^{k})=[2\tilde{b}ₘ^{k}−1]δ_{m,k}⁽1- b̅^{ₘ}^{^{k)}} (7)

The values of M (surviving candidates per depth) and N-term (the number of candidates used for gathering soft information based on early terminated paths) can be varied to trade off computation complexity with bit-error-rate performance. In the iterative decoding setting, in each iteration cycle, each decoder computes extrinsic information that is passed as input (appropriately deinterleaved in the case of the MIMO demapper, and reinterleaved in the case of the outer MAP decoder) to the other decoder. The extrinsic information is computed as the difference between the soft output information produced by the decoder (e.g., in the case of MIMO demapper see equation (7)), and the input intrinsic information to the decoder. Typically, the extrinsic information passed between decoders for any given particular bit location is in the form of differential values, that is the difference between the “bit=1” value and the “bit=0” reliability value. If iterative decoding is used, the metric used for SOMA decoding shown in equation (6) is modified to include an extrinsic term. In particular, another term is added to the right hand side of equation (6), which is a sum of terms, one term for each bit location in the binary representation of the symbol \tilde{s}. When differential reliability values are employed, the term added that corresponds to any given, but fixed, bit location, equals zero if the bit-value of that bit location in \tilde{s} is 0, and equal to the differential input reliability value otherwise.

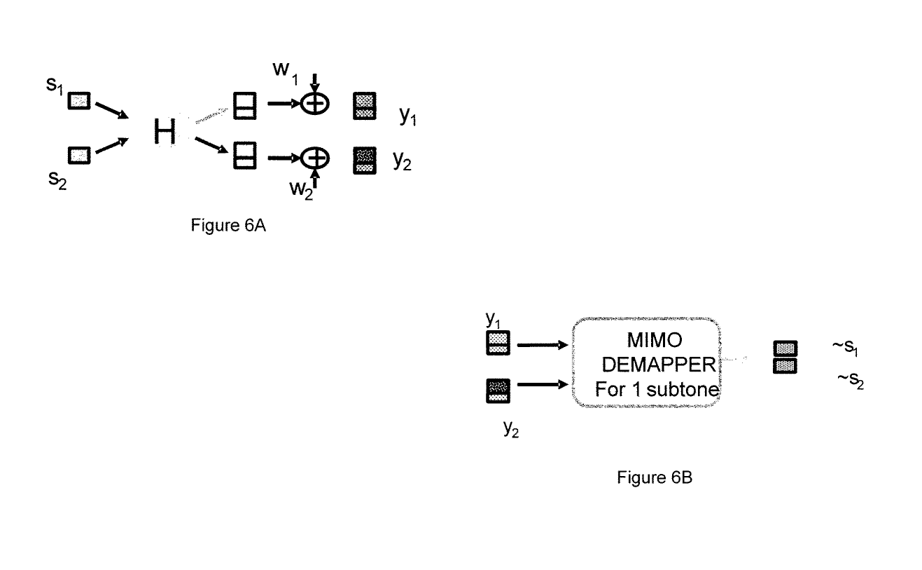

FIGS. 6A and 6B illustrate the operation of the MIMO demapper for one subtone for a simple 2×2 example. Referring to FIG. 6A, the y₁ and y₂ signals are generated from the symbols s₁ and s₂ from first and second antennas. This occurs in a well-known fashion according to the following:

$$⌊ \begin{matrix}{y}_{1} \\ {y}_{2}\end{matrix} ⌋ = ⌊ \begin{matrix}{H}_{11} & {H}_{12} \\ {H}_{21} & {H}_{22}\end{matrix} ⌋ ⌊ \begin{matrix}{s}_{1} \\ {s}_{2}\end{matrix} ⌋ + ⌊ \begin{matrix}{w}_{1} \\ {w}_{2}\end{matrix} ⌋$$

In this case, s is a vector of size Nₜ=Nᵣ=N=2, and each entry of s corresponds to a constellation symbol.

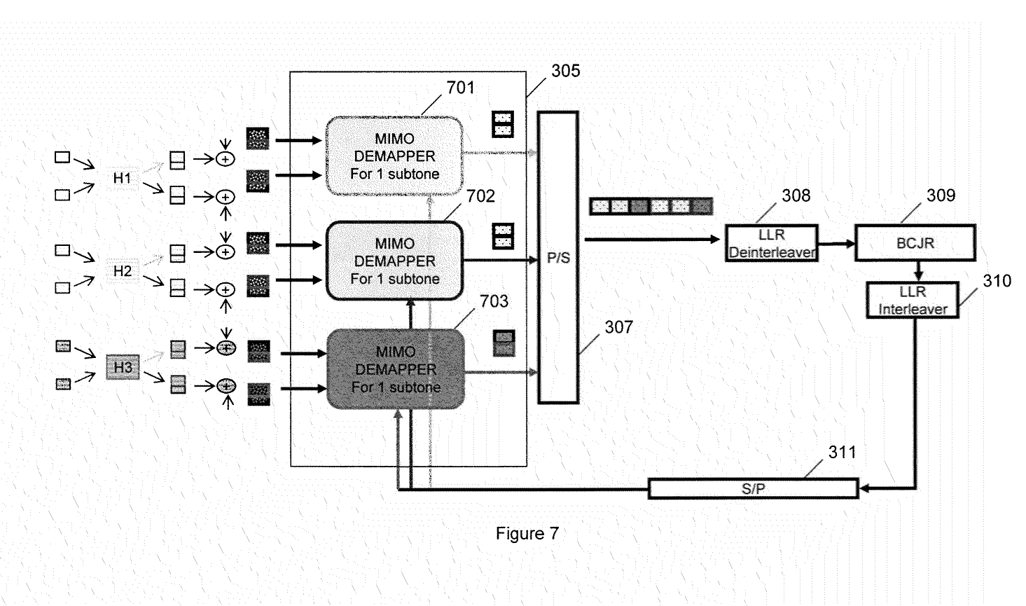

The MIMO demapper receives y₁ and y₂ signals and returns estimates of the bits represented by the symbols s₁ and s₂, for one subtone as shown in FIG. 6B. In addition, soft-output (reliability information) is provided on the set of estimated bits. FIG. 7 illustrates another representation of the receiver of FIG. 3 in which each MIMO demapper for each subtone is shown.

After the QR-decomposition, two scalar measurements are obtained in the form described in equation (4). For illustration purposes, consider the permutation order π corresponding to the order s₁, s₂. Due to the structure of the L^{π} matrix in (4), the first measurement in \tilde{y} only depends on s₁ while the second depends on both s₁ and s₂. Next, the metric in equation (6) is considered, which in this case is a sum of two terms. The first term (m=1) is the term due to the first measurement in \tilde{y} and only depends on s₁. The second term (m=N=2) is term due to the second measurement (and consists of an l₁₂ and an l₂₂ term). This structure allows the computation of each of the metrics in (6) to be performed on a tree. At the first level of the tree only the first terms (m=1) in the sums in (6) are computed. Since these depend only on s₁ the number of terms computed (and thus number of level-1 nodes in the tree) equals the number of possible values s₁ can take. In the second step, from each node at level one (each corresponding to a distinct value of s₁), leafs for each possible value of s₂ are extended, and the second term (branch metric) in the sum in equation (6) is computed and added to 1^{st} term corresponding to the particular value of s₁. In the end (level 2 in this case), there are as many end nodes as there are candidate vectors of symbols, and each node represents a computation of (6) for a specific vector symbol candidate. Those can thus be compared as in (5) to provide bit estimates and reliability information for all the bits represented by the QAM symbol vector.

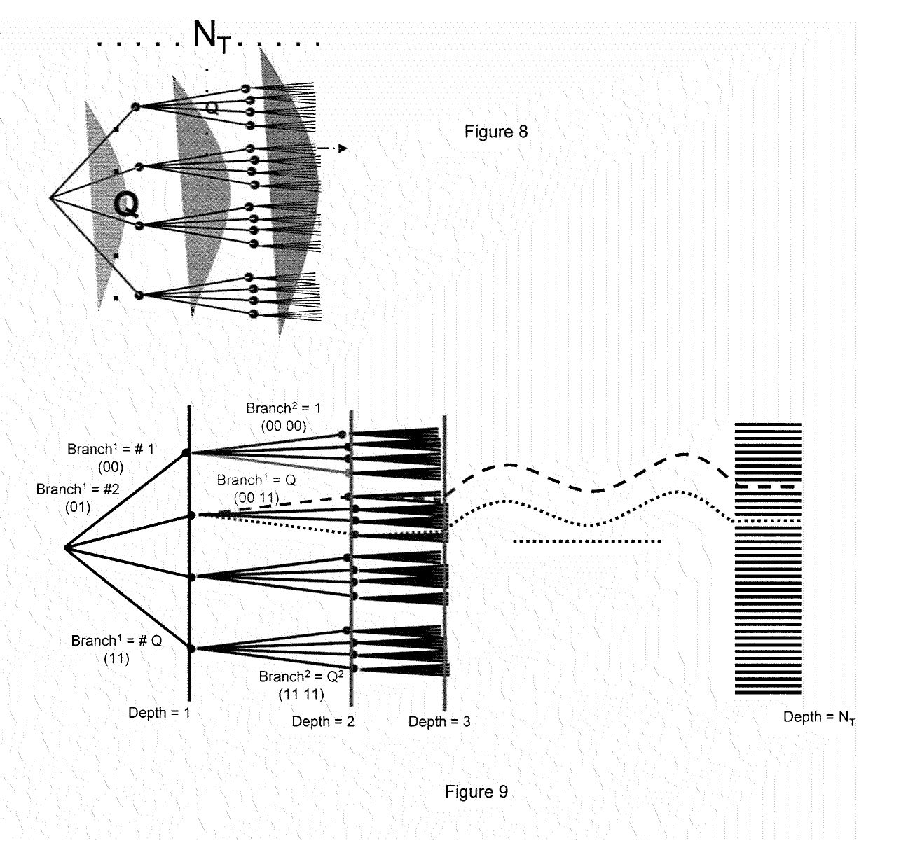

FIG. 8 illustrates the decision tree that allows this recursive computation of metrics on a tree in the case that there are three transmit antennas and thus Nₜ=Nᵣ=N=3. The SOMA algorithm does not search the full tree, but rather a limited set of paths. The way the paths are limited is to start expanding paths from the root of the tree and at each level keeping only a subset of the paths as surviving paths (i.e., as paths that will be further extended). Referring to FIG. 8, at each new level of the tree, a decision is made to expand the tree for only the M best branches. This decision can be based by calculating the parial distance metric for each candidates. Specifically, at level “n”, the distance metric used for comparisons corresponds to the first “n” terms of equation (6) (i.e., the sum of all terms in equation (6) for m=1, 2, . . . , “n”). Then based on this metric the best M metrics are selected as survivors. Thus, the tree is pruned at each depth by keeping only the best M paths. This is represented in FIG. 9.

Note that the SOMA detection process also calculates the soft (reliability) information on each bit, besides choosing the best path, in a manner well-known in the art.

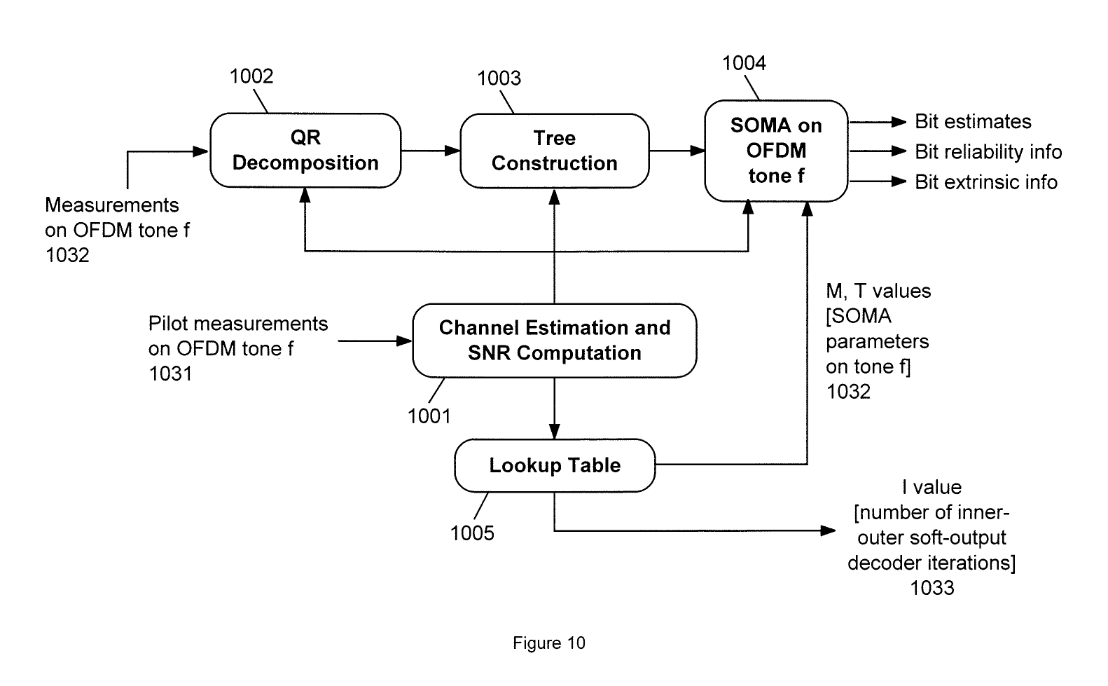

In one embodiment, the complexity of the inner SOMA decoder is controlled by the values of the parameters M (the number of best paths) and T (the early-terminated paths). The overall complexity is also controlled by the number of times the inner decoding algorithm is used, which, in turn, is determined by the number of OFDM tones and the number of iterations (I) used for iterative decoding. FIG. 10 is a flow diagram of one embodiment of a process for setting up the SOMA inner decoding operation on tone n. The process is performed by processing logic that may comprise hardware (e.g., circuitry, dedicated logic, etc.), software (such as is run on a general purpose computer system or a dedicated machine), or a combination of both. The process is performed on each tone.

Referring to FIG. 10, first channel measurements are used (based on pilot signals) to estimate the channels between all transmit-receive antenna pairs on any given tone f (this would correspond to estimating the channel matrix H[f]) (1001). The channel estimation and SNR computation are based on pilot measurements on OFDM tone f (1031). The channel estimates and lookup table (LUT) 1005 are used to set up the adaptivity (e.g., changing M, T of the I) of SOMA.

More specifically, these measurements are used to set up the QR-decomposition of the channel matrix, set up the SOMA detection tree (1003), and select (e.g., by means of a lookup table) the parameters of the SOMA algorithm (1004). As the flow diagram reveals, the selection of these parameters depends on the channel conditions. Then, once the QR-decomposition (1002), detection tree (1003), and SOMA parameters have been set (1004), the measured data on all receive antennas on tone f (1032) are processed through a QR-decomposition (1002) to generate a set of effective channel measurements, the tree is constructed (1003) and then the SOMA inner detection algorithm is implemented. The SOMA is implemented on OFDM tone f using SOMA parameters on tone f provided by LUT 1005. The output of LUT 1005 may provide one or more variable values of the SOMA parameters on tone f, namely M, T (1032), and the number of inner-outer soft-output decoder iterations, namely I (1033). That is, LUT 1005 may specify the value of M (when M is adaptive) while the values of T and I are unchanged (non-adaptable), or the value of T (where T is adaptable) while the value of M and I are unchanged (non-adaptable). The same could occur for 2 or more of the values of M, T and I. These values may be clanged at different depths/levels of the tree, such that adaptation occurs over different levels. In such a case, adaptation occurs based on tone quality and on depth. In an alternative embodiment, a LUT is not used and the values are changed in the SOMA algorithm itself. In such a case, in one embodiment, the values are thresholded in the algorithm. For example, if the channel estimate for the tone falls within a first range, a certain value of M is used (e.g., M=8), but if the channel estimate of the tone falls in another range, then a different value of M is used (e.g., M=12). These changes in value may also be based on the number of transmit antennas, the rate of the outer binary code, etc. Note that certain values may change based on whether the group of the paths with the best metrics have metrics that are clustered together, such that those in the cluster (more or less than M) or having values within a certain percentage of the worst metric in the cluster (e.g., with 95% of the value of the lowest quality metric in the cluster) are permitted to continue to the next level/depth in the tree. The resulting set of survivors may have cardinality more or less than M. Alternatively, the process may keep as survivor paths, all the paths whose relative metrics are within a certain percentage (e.g., 95%) of the metric of the best path. The outputs of the SOMA inner detection algorithm are bit estimates, bit relativity information and bit extrinsic information.

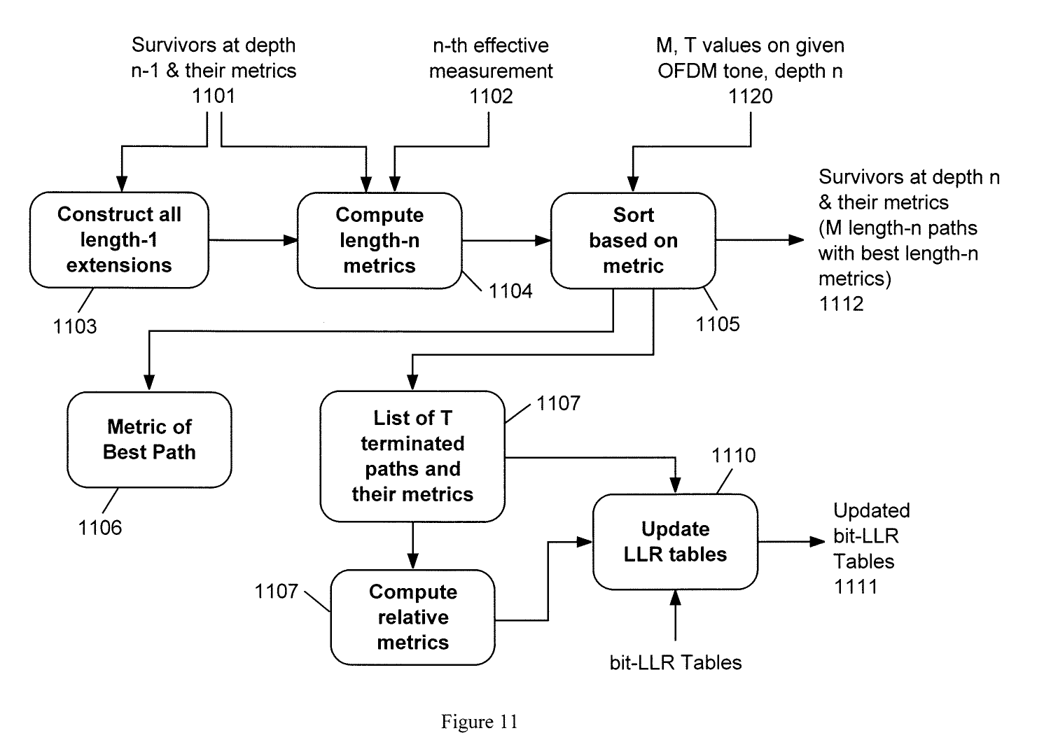

A flow diagram of the SOMA detection process at depth n is shown in FIG. 11. Referring to FIG. 11, the main input is the set of survivors at depth n−1 and the metrics of these survivor paths (1101). First, all the possible length-1 extensions of each of these length-“n−1” paths are constructed based on the survivors of the pervious depth and their metrics (1101) to generate the set of all length-n paths that will be visited by the algorithm. Then the survivor metrics at depth n−1 (1101) and the effective measurement at depth n (1102) are used to compute the length-n metrics (1104) of these length n paths that are constructed at 1103. Based on parameter values of M and T on a given OFDM tone, depth n (1120), the paths are then sorted based on their metric quality (1105). The M paths with the best metrics are chosen as survivors at depth n (1112), in the same manner as the well-known SOMA process. The rest of the paths are put in the list of the paths that are terminated (1107). For each one of these paths, a relative metric is computed (1109) with respect to the best path at length n (which, obviously is a survivor path). Then for each of the terminated paths, its relative metric is compared against a subset of entries in the bit-LLR (Least Likelihood ratio) table to decide whether or not that entry is to be updated. In particular, if the kth bit in the representation of the mth symbol is 0, the (k,m) entry of Δ⁽⁰⁾ is updated (1108); else the (k,m) entry of Δ⁽¹⁾ is only updated (1108). The entry gets updated if the relative metric provided by the new path improves the metric in the associated entry in the LLR table. The output is updated bit-LLR tables (1111).

In one embodiment, the different SOMA detectors are used for the different tones and are selected adaptively based on the quality of the tones. For a tone with good quality (high signal level, or high SNR), the M-value can be lowered and/or the T-value can be lowered and/or the I value can be lowered. [The range of values for M and T vary as a function of number of transmit streams (number of transmit antennas) N, the size of the QAM constellation employed and the rate of the outer code in the system. As an example, based on experiments in 4 by 4 16 QAM MIMO, M=16 suffices to get near optimal performance. However, this value increases with increasing number of streams and QAM constellations. Typically, a (precomputed) lookup table can be employed that lists the value of M (and T) that should be used for set of SNR (or signal level) ranges. This approach yields lower relative complexity for that particular SOMA detector. On the other hand, for a tone (OFDM subchannel) of poor quality (low signal level or low SNR), higher values will be chosen for all or a subset of M and T and I. One approach for instance corresponds to setting a target performance in bit-error-rate at the mobile (this can be preset by the application). In this case, the higher the SNR on the tone, the lower the value of M needed to achieve the desired performance. As the SNR is reduced, the opposite effect takes place. However, there is an SNR level such that lowering the receive SNR beyond that value makes it impossible to achieve the desired performance at the mobile (no matter what the complexity). Beyond that level, either the maximum allowable value of M is used or the event is declared in outage. This leads to a higher value of complexity for this particular tone. The adaptive use of the SOMA and the number of iterations saves complexity without reduced performance. For the non-adaptive case the performance will, to a large extent, be dictated by the worst-quality tone, which corresponds to the highest relative complexity for the SOMA detectors.

In another embodiment, the allocation of complexity may be done over successive OFDM symbols, i.e., over time. For instance, resources could be jointly allocated over frequency (OFDM tone) as well as time, so that the complexity does not exceed a predetermined value over a block of OFDM symbols.

In yet another embodiment, the value of M is changed inside one SOMA detector, i.e., search the tree with a variable number of expanded paths as well as a variable number of used early terminated paths at each level in the soft output calculations.

In yet another embodiment, a metric correction term is applied for the soft output M-algorithm, much the same as the one used in the corrected SOVA algorithm described in S. Lin and D. J. Costello Jr., “Error Control Coding, 2^{nd} Edition”, Prentice Hall, New York, 2003 and Kitty Wong, “The Soft Output M-algorithm and its applications”, Ph.D. Thesis, Queens University, Kingston, Canada, August 2006.

Note that the techniques described herein for a low complexity receiver need not be limited to a system employing OFDM modulation.

### ADVANTAGES OF EMBODIMENTS OF THE INVENTION

One advantage of embodiments of the present invention is that it provides a method for a high performing inner joint demapper with soft output, with an overall complexity that makes it implementable in an iterative decoding setting for N and B values for which the MaxLogMAP is not implementionally feasible or practical with today's technology. Such embodiments include one or more of the following elements:
1. An OFDM based system with one MIMO detector for each tone, where the complexity reduction in the SOMA based detector is implemented adaptively with the quality of each tone, yielding the best overall complexity for a certain performance level.
2. A SOMA detector for each tone, where the M and the T values are chosen adaptively based on the tone quality, and where the number of iterations for iterative-decoding are also chosen adaptively based on the tone quality.
3. The M value may vary over the decoding tree.
4. Adaptive resource and complexity allocation may also be done over successive OFDM symbols, i.e., over time; and
5. The MaxLogMAP metric is modified to a corrected metric in the bit-LLR calculations.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

We claim:

1. A device for use in a wireless communication system having a transmitter, the device comprising:
a receiver to receive information-bearing signals from the transmitter wirelessly transmitted using OFDM and bit interleaved coded modulation, the receiver comprising an inner decoder structure having a soft output M-algorithm (SOMA) based multiple-in multiple-out (MIMO) joint demapper that uses a SOMA-based MIMO detection process to perform joint inner demapping over each subtone, the SOMA-based MIMO joint demapper being operable to identify a best candidate among a number of candidates by searching a detection tree under control of a parameter representing a total number of paths that are extended from each level, such that only a number of best alternatives from every level of the tree are expanded, wherein the SOMA-based MIMO detection process adapts one or more of the parameters based on tone quality.

2. The device defined in claim 1 wherein the SOMA-based detection process calculates soft output values by comparing a locally estimated best path at each depth in the detection tree with corresponding alternative paths that are not further extended at each depth.

3. The device defined in claim 1 further comprising a soft-in soft-out (SISO) decoder to use the soft output values from the inner SOMA-based MIMO joint demapper to produce output data, wherein the SISO decoder feeds soft values back to the inner decoder structure for iterative decoding.

4. The device defined in claim 1 wherein the SOMA-based MIMO detection process is adaptable based on a number of early-terminated paths in the tree (T), which is used in soft output value calculations.

5. The device defined in claim 1 wherein the SOMA-based MIMO detection process is adaptable based on number of iterations for each tone based on tone quality.

6. The device defined in claim 1 wherein the SOMA-based MIMO detection process is adaptable during each iteration and for every tone based on tone quality.

7. The device defined in claim 1 wherein tone quality is based on channel estimates.

8. The device defined in claim 1 wherein the quality of OFDM tones is based on signal level.

9. The device defined in claim 1 wherein the quality of OFDM tones is based on signal-to-noise ratio (SNR).

10. The device defined in claim 1 wherein the SOMA-based MIMO joint demapper includes a plurality of SOMA detectors, one for each tone, and wherein the parameter changes per tone inside one SOMA detector, such that the search of the tree occurs with a variable number of expanded paths as well as a variable number of use early terminated paths at each level in the soft output calculations.

11. The device defined in claim 1 wherein the receiver further comprises an outer decoder communicably coupled to receive the output from the inner decoder structure and generate a soft output.

12. The device defined in claim 11 wherein the outer decoder comprises a BCJR decoder.

13. The device defined in claim 11 wherein the outer decoder is operable to generate feedback information to the inner decoder structure for use in iterative decoding.

14. The device defined in claim 11 wherein the outer decoder comprises a soft-input hard-output decoder for use without iterative decoding.

15. The device defined in claim 14 wherein the soft-input hard output decoder comprises a Viterbi decoder.

16. The device defined in claim 1 wherein the receiver further comprises:
a plurality of antennas;
a plurality of fast Fourier transform (FFT) modules, each of the plurality of FFT modules coupled to receive signals from one of the plurality of antennas; and
an outer decoder associated with an outer binary encoder to decode a first set of data output by the demapper to produce output data from the receiver.

17. The device defined in claim 16 wherein the outer decoder comprises a MAP decoder for the outer encoder, and the outer binary encoder comprises an outer convolutional encoder.

18. The device defined in claim 16 wherein the outer decoder is one of a group consisting of a MAP decoder, a MaxLogMAP decoder, and a turbo-type decoder, each for an encoder that comprises one of a group consisting of a binary rate-compatible punctured convolutional (RCPC) code, a binary turbo code and a binary LDPC code.

19. A method comprising:
evaluating quality of individual OFDM tones received by a receiver in a wireless communication system; and
performing a first decoding operation to produce a first set of output data representing most likely transmitted bit estimation values and information about the reliability of each of these estimates, including
performing a SOMA-based MIMO detection process over each subtone for joint inner demapping, by identifying a best candidate among a number of candidates by searching a detection tree under control of a parameter representing a total number of paths that are extended from each level, and by computing reliability information for all bits under the control of a parameter representing the number of early terminated paths, wherein one or more parameters are determined based on the evaluated quality of the OFDM tone.

20. The device defined in claim 19 wherein performing a first decoding operation further comprises calculating soft output values by comparing an estimated best path with best alternative paths branching off the best path, wherein each are terminated at the end of the tree or non-terminated at every level.

21. The device defined in claim 19 wherein performing a first decoding operation further comprises using the soft output values from the inner SOMA-based MIMO detection process to produce output data, by use of a soft-output outer decoder and feeding soft values back to an inner decoder structure performing the first decoding operation for iterative decoding.

22. The device defined in claim 19 further comprising setting one or more of the number of survivors, a number of early-terminated paths in the tree, and a total number of iterations based on tone quality.

23. The method defined in claim 19 further comprising selecting a number of iterations for a given tone adaptively based on the quality of the individual OFDM tones.

24. The method defined in claim 19 further comprising adapting a number of iterations to different OFDM blocks in a time sequence.

25. The method defined in claim 19 wherein the quality of OFDM tones is based on signal level.

26. The method defined in claim 19 wherein the quality of OFDM tones is based on signal-to-noise ratio (SNR).

27. The method defined in claim 19 further comprising performing a second decoding operation with an outer decoder designed for the binary outer encoder.

28. The method defined in claim 27 wherein the outer decoder comprises a decoder for the outer convolutional encoder.

29. The method defined in claim 27 wherein the outer decoder is a MAP MaxLogMAP or turbo-type decoder associated with an encoder that comprises one of a group consisting of a binary rate-compatible punctured convolutional (RCPC) code, a binary turbo code and a binary LDPC code.
